(19) United States
(12) Patent Application Publication
(10) Pub. No.: US 2021/0097095 A1
(43) Pub. Date: Apr. 1, 2021

(54) APPARATUS, SYSTEM AND METHOD OF USING TEXT RECOGNITION TO SEARCH FOR CITED AUTHORITIES

(71) Applicants: Thomas Peavler, Keller, TX (US); Donna Peavler, Keller, TX (US)

(72) Inventors: Thomas Peavler, Keller, TX (US); Donna Peavler, Keller, TX (US)

(21) Appl. No.: 17/013,164

(22) Filed: Sep. 4, 2020

Related U.S. Application Data
(60) Provisional application No. 62/895,827, filed on Sep. 4, 2019.

(51) Int. Cl. G06F 16/332; G06K 9/00; G06F 40/134; G06F 16/33; G06N 20/00

(52) U.S. Cl. CPC G06F 16/332; G06K 9/00456; G06N 20/00; G06F 16/3335; G06F 40/134

(57) ABSTRACT

An apparatus, method and system for electronically providing an underlying cited document from an image. The apparatus, system and method include: an input capable of receiving an image from a camera of a mobile device; an automated text-recognition feature capable of recognizing text in the image; an extractor capable of extracting citations from the recognized text; a comparative database capable of comparing the extracted citations to a plurality of prospective citation types in order to assess a citation type of the extracted citations; based on the assessed citation type, a citation recognizer to recognize the extracted citation; and a user interface capable of presenting the underlying cited document corresponded to the recognized citation.

### CROSS-REFERENCE TO RELATED APPLICATIONS

This application claims priority to U.S. Provisional Application Ser. No. 62/895,827, filed on Sep. 4, 2019.

### FIELD OF THE DISCLOSURE

The field of the invention relates to discerning citations, and more particularly to an apparatus, system and method of using text recognition and computing algorithms to query appropriate databases and extract cited documents therefrom.

### BACKGROUND OF THE DISCLOSURE

There are a plurality of different fields of endeavor in which principal documents regularly cite to other documents external to each principal document. Chief among these fields is the use of legal citations in the legal field.

However, such circumstances typically require the user to spot the citation in a document, retain that citation, either by memory or in written form, go look up the cited document, and then obtain a copy of the cited document for review. Further, this process does not account for typographical errors in citations that may make the underlying cited document difficult if not impossible to locate.

Thus, the need exists for an apparatus, system and method of more efficiently spotting citations in a document, discerning those cited documents, and then obtaining copies of those cited documents.

### SUMMARY

The disclosure is and includes an apparatus, system and method for using text recognition and computing algorithms to query appropriate databases and extract cited documents therefrom. The embodiments may enable a user to bypass a manual search for citations, such as legal authorities (e.g., legal opinions, statutes, etc.), through the use of text-recognition software. The software utilizes a proprietary, self-learning algorithm to locate, identify, and extract legal citation(s) from an image of an external source. It then selects the appropriate database(s) containing legal authorities based on the type of citation extracted, queries the relevant authority(ies), and displays the result to the user. The software is designed to adapt with changes to citation, such as legal citation, styles.

More specifically, the apparatus, method and system for electronically providing an underlying cited document from an image may include: an input capable of receiving an image from a camera of a mobile device; an automated text-recognition feature capable of recognizing text in the image; an extractor capable of extracting citations from the recognized text; a comparative database capable of comparing the extracted citations to a plurality of prospective citation types in order to assess a citation type of the extracted citations; based on the assessed citation type, a citation recognizer to recognize the extracted citation; and a user interface capable of presenting the underlying cited document corresponded to the recognized citation.

Therefore, the disclosure provides an apparatus, system and method of more efficiently spotting citations in a document, discerning those cited documents, and then obtaining copies of those cited documents.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the disclosure. Moreover, in the figures, like reference numerals may or may not designate corresponding parts throughout the different views. Moreover, all illustrations are intended to convey concepts, where relative sizes, shapes and other detailed attributes may be illustrated schematically rather than literally or precisely. More specifically, in the drawings:

FIG. 1 illustrates aspects of the embodiments; and

FIG. 2 illustrates aspects of the embodiments.

### DETAILED DESCRIPTION

The figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical surgical, and particularly ophthalmic surgical, devices, systems, and methods. Those of ordinary skill may thus recognize that other elements and/or steps may be desirable or necessary to implement the devices, systems, and methods described herein. Because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art.

Embodiments are provided throughout so that this disclosure is sufficiently thorough and fully conveys the scope of the disclosed embodiments to those who are skilled in the art. Numerous specific details are set forth, such as examples of specific aspects, devices, and methods, to provide a thorough understanding of embodiments of the present disclosure. Nevertheless, it will be apparent to those skilled in the art that certain specific disclosed details need not be employed, and that embodiments may be embodied in different forms. As such, the exemplary embodiments set forth should not be construed to limit the scope of the disclosure.

The terminology used herein is for the purpose of describing particular embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on”, “upon”, “connected to” or “coupled to” another element or layer, it may be directly on, upon, connected or coupled to the other element or layer, or intervening elements or layers may be present, unless clearly indicated otherwise. In contrast, when an element or layer is referred to as being “directly on,” “directly upon”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements or aspects, these elements or aspects should not be limited by these terms. These terms may be only used to distinguish one element or aspect from another. Thus, terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the disclosure.

Processor-implemented modules and print systems are disclosed herein that may provide access to and transformation of a plurality of types of digital content, including but not limited to tracking algorithms, triggers, and data streams, and the particular algorithms applied herein may track, deliver, manipulate, transform, transceive and report the accessed data. Described embodiments of the modules, apps, systems and methods that apply these particular algorithms are thus intended to be exemplary and not limiting.

An exemplary computing processing system for use in association with the embodiments, by way of non-limiting example, is capable of executing software, such as an operating system (OS), applications/apps, user interfaces, and/or one or more other computing algorithms, such as the tracking, algorithms, decisions, models, programs and subprograms discussed herein. The operation of the exemplary processing system is controlled primarily by non-transitory computer readable instructions/code, such as instructions stored in a computer readable storage medium, such as hard disk drive (HDD), optical disk, solid state drive, or the like. Such instructions may be executed within the central processing unit (CPU) to cause the system to perform the disclosed operations. In many known computer servers, workstations, mobile devices, personal computers, and the like, the CPU is implemented in an integrated circuit called a processor.

It is appreciated that, although the exemplary processing system may comprise a single CPU, such description is merely illustrative, as the processing system may comprise a plurality of CPUs. As such, the disclosed system may exploit the resources of remote CPUs through a communications network or some other data communications means.

In operation, CPU fetches, decodes, and executes instructions from a computer readable storage medium. Such instructions may be included in software. Information, such as computer instructions and other computer readable data, is transferred between components of the system via the system's main data-transfer path.

In addition, the processing system may contain a peripheral communications controller and bus, which is responsible for communicating instructions from CPU to, and/or receiving data from, peripherals, such as operator interaction elements, as discussed herein throughout. An example of a peripheral bus is the Peripheral Component Interconnect (PCI) bus that is well known in the pertinent art.

An operator display/graphical user interface (GUI) may be used to display visual output and/or presentation data generated by or at the request of processing system, such as responsive to operation of the aforementioned computing programs/applications. Such visual output may include text, graphics, animated graphics, and/or video, for example.

Further, the processing system may contain a network adapter which may be used to couple to an external communication network, which may include or provide access to the Internet, an intranet, an extranet, or the like. Communications network may provide access for processing system with means of communicating and transferring software and information electronically. Network adaptor may communicate to and from the network using any available wired or wireless technologies. Such technologies may include, by way of non-limiting example, cellular, Wi-Fi, Bluetooth, infrared, or the like.

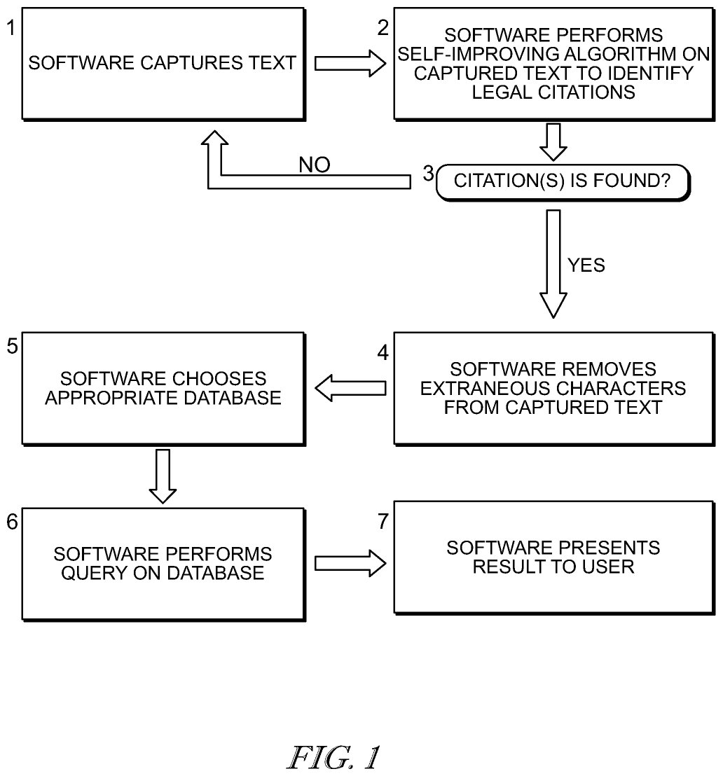

Referring now to FIG. 1, the embodiments may use text-recognition software to extract text from an image of an external source 1. The disclosed software may be, by way of example, an application or mobile “app”, and thus may be able to run on any device with image-capturing capabilities. As used herein, image-capturing capabilities may include optical character recognition (OCR) or other optical readers that provide an electronic conversion of images of typed, handwritten or printed text into machine-encoded text. The image capturing discussed herein may be provided by way of non-limiting example, from a scanned document, a document photo, a scene-photo, or from superimposed text on an image. Thus, optical scanning may occur on text files, image files, pdf files, CAD drawing files, fax files, email files, and the like.

Still with reference to FIG. 1, the disclosed engine and system may run the captured text through an algorithm designed to distinguish citations, such as particularly legal citation(s) that reference legal authorities, which may include opinions, statutes, etc., from other text characters and strings. 2. This algorithm may, by way of example, reside either in the app/application, in whole or in part, and/or may be at least partially resident in the cloud, such as via accessibility from a network connection.

The algorithm may use, in part, pre-entered rule set(s) in conjunction with machine learning (such as may occur via manual or automated feedback regarding the veracity of conclusions drawn pursuant to the pre-entered rule set) to identify the unique style of certain types of references and citations, such as may include specific citation-types, hyperlinks, and the like. For example, legal citation types are outlined in The Bluebook, in other Rules of Form, in legal precedent, and in colloquial usage of cites (“Citation Reference Guides”), whether the legal citation is a stand-alone citation or embedded in a block of text, and the disclosed engine and system may be capable of recognizing all such citations indicative, such as within a certain likelihood probability, of being legal citations.

As such, the application or app may be capable of recognizing any citation, and then automatically discerning the type of citation (i.e., legal, accounting, hyperlink). Additionally and alternatively, the embodiments may “spot” citations, and may allow the user to indicate the specific type of citation, such as may be selected from a hierarchy of available citation types.

Accordingly, the algorithm may, in combination, substantially simultaneously review multiple Citation Reference Guides, and may return a best-approximation for each citation reviewed, based on a best format match to the recognized text for a given citation. As such, the embodiments may include confidence intervals, such as wherein only matches meeting a certain confidence interval (i.e., more than 50% likely to be correct) are returned to the user. The confidence level may or may not be visible to the user, and the user may or may not be shown the confidence level of a given prospective match.

As referenced, using machine learning the disclosed algorithm may be initially trained from the rules outlined in Citation Reference Guides, such as for legal citations, by way of non-limiting example. The machine learning may then adapt as the Citation Reference Guides change and evolve, and/or as automated or user feedback reflects positive and negative outcomes for citations obtained.

That is, using error-probability formulae well-understood to the skilled artisan, the disclosed algorithm may identify any close match to a possible citation, isolate potential errors that indicate an error or transposition of the citation, and offer optionality and/or a confidence interval as to the likely citation type. Similarly, the application or app may provide suggestions to correct the erroneous citation to obtain a type-match. Yet further, upon recognition of a citation type-match, the embodiments may include error-correction artificial intelligence (AI) in the machine learning, wherein the AI enables an auto-correction of the citation to a recognized citation based on, for example, common spelling errors, common numeric or alphabetic transpositions, and so on. Additionally, the aforementioned machine learning may comprise a rules-modification module, wherein the foregoing aspects are encompassed in machine-learned modifications to the citation rules over time.

With particular reference to FIG. 1, if a citation(s)-type match is found 2, a citation may be sought and/or found 3. Upon selection of citation type, and a discerning of a citation within the aforementioned confidence level, which may include isolation of the citation(s) from the rest of the text by eliminating extraneous characters 4, the application may use the assessed type to hierarchically elect the relevant citation-database(s) 5. That is, the algorithm analyzes the citation(s) to identify which database(s) likely contains the referenced authority.

Using the isolated citation, the software then performs the proper query in the appropriate database(s) 6 and presents the source authority(ies), such as the source legal authority, to the user 7. If a citation(s) is not found 3, the software may captures additional text for comparison to a context estimator 11, and may start the process over 1.

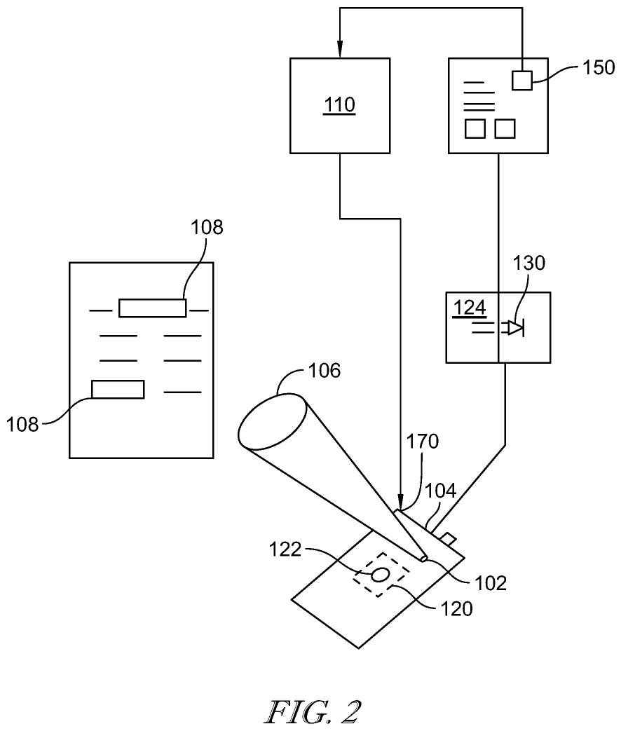

As shown in FIG. 2, the embodiments may advantageously use the camera feature 102 of a mobile device 104 to capture an image 106 containing citations 108, such as legal citation(s), from an external source 110. A thick or thin client algorithm 120 associated with the mobile device may then employ text-recognition software 122 to the image to identify, isolate and extract known citation formats 124, such as legal, accounting, technical, sports-related, or like citation(s) from the image, such as by use of software comparator 130. By way of example, the algorithm 120 may isolate legal citations by analyzing text against Citation Reference Guides to identify and eliminate extraneous text, and may then extract those legal citations.

Using comparator 130, algorithm 120 may analyze the type of citation to identify the appropriate database(s) 150 in which referenced the authorities referenced in the citation are likely contained. The authority 110 referenced in the citation 108 may then be extracted from the appropriate database 150, and provided to the user for review, such as in the user interface 170 of the mobile device on which the algorithm 120 at least partially operates.

Therefore, the embodiments provide a zero- or one-step searching for users to find and display source material from a citation, such as legal opinions, statutes, and other legal authorities, using at least text-recognition software. More particularly, the disclosed application, or “app”, may operate simply by discerning citations through pointing a mobile device at text (i.e., zero-step searching), or through a single user interaction to execute the image and the discerning of citation.

Although the disclosure has been described and illustrated in exemplary forms with a certain degree of particularity, it is noted that the description and illustrations have been made by way of example only. Numerous changes in the details of construction, combination, and arrangement of parts and steps may be made. Accordingly, such changes are intended to be included within the scope of the disclosure.

What is claimed is:

1. A system for electronically providing an underlying cited document from an image, comprising:
an input capable of receiving an image from a camera of a mobile device;
an automated text-recognition feature capable of recognizing text in the image;
an extractor capable of extracting citations from the recognized text;
a comparative database capable of comparing the extracted citations to a plurality of prospective citation types in order to assess a citation type of the extracted citations;
based on the assessed citation type, a citation recognizer to recognize the extracted citation; and
a user interface capable of presenting the underlying cited document corresponded to the recognized citation.

2. The system of claim 1, wherein the underlying cited document is obtained from a hyperlink.

3. The system of claim 1, wherein the underlying cited document is obtained from a related database.

4. The system of claim 1, wherein the extracted citation is a legal citation.

5. The system of claim 1, wherein the system comprises a thick client mobile app.

6. The system of claim 1, wherein the system comprises a thin client mobile app.

7. The system of claim 1, wherein the automated text-recognition feature comprises an optical character recognizer.

8. The system of claim 1, wherein the image is of one of typed, handwritten or printed text.

9. The system of claim 1, wherein the image is one of a scanned document, a document photo, a scene-photo, or superimposed text on a scene photo.

10. The system of claim 1, wherein the image is one of a text file, an image file, a pdf files, a CAD drawing file, a fax file, or an email file.

11. The system of claim 1, wherein the extracted citation is to one of an opinion or a statute.

12. The system of claim 1, wherein at least the automated text-recognition feature, the extractor, the comparative database, and the citation recognizer comprise machine learning tools.

13. The system of claim 12, wherein the machine learning tools learn from feedback.

14. The system of claim 13, wherein the feedback is automated.

15. The system of claim 13, wherein the feedback is manual.

16. The system of claim 1, wherein the extractor comprises an error-correction artificial intelligence (AI).
